(19) United States
(12) Patent Application Publication
(10) Pub. No.: US 2017/0323579 A1
(43) Pub. Date: Nov. 9, 2017

(54) TRAINING MODULE

(71) Applicant: Don R. Hancock, Frisco, TX (US)

(72) Inventor: Don R. Hancock, Frisco, TX (US)

(21) Appl. No.: 15/149,073

(22) Filed: May 6, 2016

(51) Int. Cl. G09B 9/00; G09B 19/00

(52) U.S. Cl. CPC G09B 9/003; G09B 19/003

(57) ABSTRACT

A new and improved training module is describe herein. One embodiment of the invention includes a training combat knife. The training combat knife includes: at least one contact surface of the system; a microprocessor that processes a count relating to the amount of times the at least one contact surface touches another surface outside of the mobile training system; a storage that records the count; and a communications module that transmits the count.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is an illustration of one embodiment of the present invention; and

FIG. 2 is an illustration of another embodiment of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

Knife fighting isn't about fighting, it's about surviving and defending yourself against attack. If you want to learn to defend yourself with a knife, you need intelligence, balance, and precision. An individual can learn to carry knives safely and legally, as well as how to defend themselves properly against potential attacks.

Knife Fighting is one of the most dangerous forms of combat and it is also known as knife combat or blade combat. In essence, knife fighting is a violent confrontation where both one persona and an adversary are armed with knives or some similar variation of an edged weapon.

Most people cannot just pick up a knife and expect to be good at it. Like any weapon, it takes a multitude of hours of practice to learn how to use a knife skillfully. Of course, it is not safe to just practice with any knife. It is a common practice to utilize training knives that will let a person practice with relative safety. Common practice knives come in a variety of shapes and sizes, replicating the look of many of our most popular knives in safe forms that are situated for use in close-contact training or solo practice. Many are crafted from rubber, which only enhances their flexibility and renders them quite safe for use in various drills and exercises that might require knife-on-body contact, including things like demonstrations, disarm drills, and more. They do, however, possess a bit of firmness that helps the knife keep its shape, so one is to always exercise caution, as well, by wearing proper safety gear and avoiding directed strikes to the neck and face. Some training knives are made from polypropylene or other durable plastics, giving them a greater strength, as well as a much hardier impact. Thus, some might be more stiff or solid than others. In combat knife training, a person wants to hone their skills with a knife and want something to practice with that looks like a knife and feels like knife, but does not cut like a knife. A training knife should have that great, realistic look, without any of the hazard or danger that an actual, sharpened steel blade might present.

For example, a certified Krav Maga instructor (Israeli based hand to hand, knife, gun combat) teach students the art of self defense and attack in order to protect themselves from the most aggressive assailants. Part of the usual curriculum deals heavily with weapons use and disarmament. However, an utter lack of accountability by a student is sometimes shown when dealing with weapons training. For example, when a student is to disarm a “rubber” knife carrying aggressor, a less than accurate attempt is displayed. The student rushes in etc. If the aggressor had a real knife, the exercise would be very different. Though a real knife would force the student to think twice and strain to use every ounce of training to “safely” disarm the aggressor, there is a chance they could be maimed or die. Therefore one frequently used option in which to “force” accountability without the risk of death is an electro knife. These knifes produce thousands of volts and when touched produce a tremendous shock. Though generally speaking the risk of serious injury is minimized, again the students more time than not refrain from attempting a knife disarm.

Therefore a need exists to train a student with an improved combat training knife that would reflect a more realistic combat knife, but also maintain a save environment for the student and person acting as an assailant. The present invention provides all the essentials necessary to provide absolute accountability to both students while removing the fear of death or injury. Due to the present invention's features, the industry as a whole can introduce a new level of hand to hand training exercises as well as effect. The present invention collects data providing, but not limited to, how many times the knife was used, the angle, speed and contact points in real time. At the same time there is, little or no, potential injury to student acting assailant. Because the invention is a “smart knife”, the data is collected and can be viewed in real time. The training combat knife has many advantages to all current other similar products available.

The present invention as embodied as a combat training knife, includes the ability to become a more effective method of hand to knife, knife to knife and knife to hand training. In addition, the combat training knife helps students in overall discipline of knife fighting. One great advantage is ability of the combat training knife system to produce immediate results on many types of computing platforms (e.g. from iPads, Tablet PCs, smart watches, smart phone devices . . . ) by displaying real-time data. Thus, the student training can be immediately corrected and enhanced. The system can also offer virtual instructors on the computing device interacting with the data being collected in real-time as the student is training.

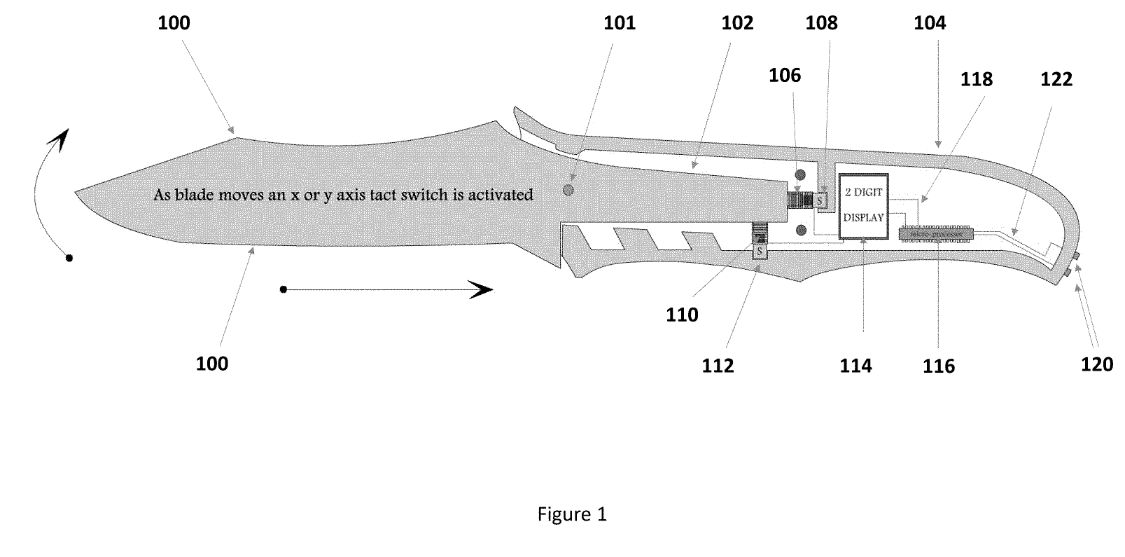

Now referring to FIG. 1, the blade 100 is composed on a front part with a sharpened bottom edge and a trop part and an inner part 102 which resides inside the handle casing 104. The blade 100 front part and the inner part 102 pivots on a pin 101. This configuration allows the blade 100, 102 to swing up/down and in/out of handle 104. Two tact switches 106, 110, which push directly on the back and bottom of the blade inner part 102, give the blade 100, 102 stability so the blade 100, 102 doesn't flop around. Moreover, two tightening springs 108, 112 adjacent to the handle casing, keep the tact switches 106, 110 in place. Further, a tightening mechanism can be included to keep the springs 108, 112 tight and in place. Thus, tightening or loosening the tension of the springs 108, 112 would increase or decrease the required pressure on the blade 100, 102 to activate either of the tact switches 106, 110.

In this embodiment, the tact switches 106, 110 count each time the inner part of the blade 102 is pushed against them and then released. The two digit display 114 connects to the switches and provides a readout of collected information from the tact switches. Moreover, the microprocessor 116 also connects to the two digit display the wiring 118. Further, the microprocessor 116 connects to the reset buttons 120 through the wiring 122. The two reset buttons 120 control the two digit display 114 and enables it change between counting/timed modes and turn the combat training unit off.

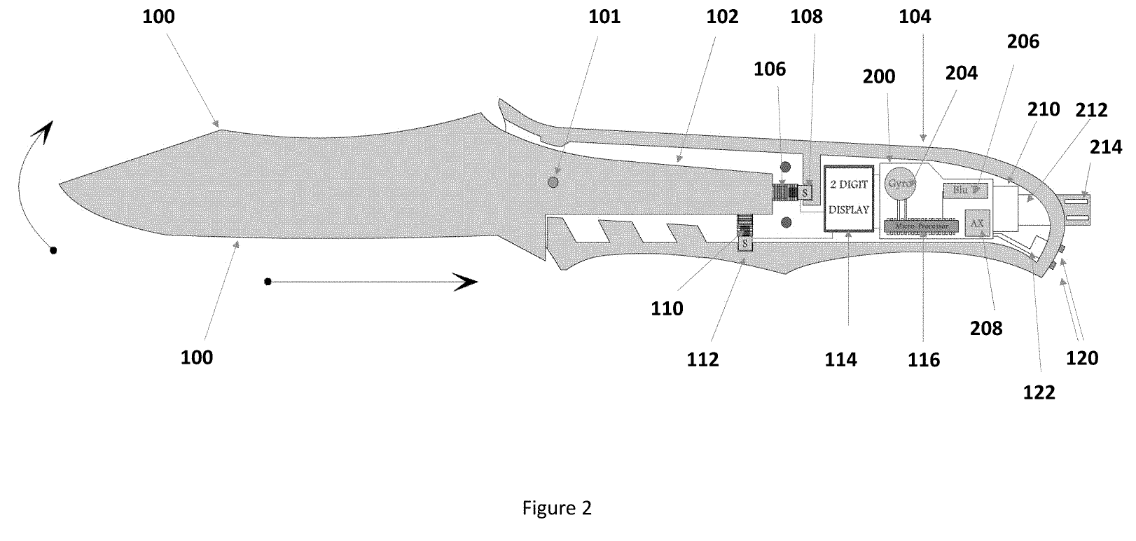

Now turning to FIG. 2, another embodiment of the present invention is shown. All the elements included in the embodiment shown in FIG. 1 also included in this embodiment. However, additional modules are included in this embodiment. Specifically, in this embodiment, a gyroscope module 200, a wireless module 206 (e.g. Bluetooth), and an acceleration module 208 are included.

The gyroscope module 200 can be used for stability and connects to the two digit display 114 by wiring 200 and directly to the microprocessor. The wiring 200 also connects the wireless 206 and the acceleration 208 modules with the gyroscope module 204.

In addition, if the wireless module 206 includes Bluetooth capabilities, the system is enabled to download software and provides a link for training software and other interactive software such as gaming. A Bluetooth capable module can also provide data transfer from the combat training knife to external devices via Bluetooth transmission.

Furthermore, an USB port 214 is also included in this embodiment. The USB port 214 can provides external connection for uploading and downloading recorded and/or data. The USB port is connected to the reset of the modules and microprocessor by the wiring module 210 and USB wiring 212. The USB port 214 also allows a hardwire connection to a power source for charging and the other uploading and/or downloading functions.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. For example the training system of the present invention can also be implemented in various platforms. A few examples, are boxing gloves, sword fighting, nunchuck and/or baton fighting. Various other similar embodiments exist that the present invention can be adapted to by a person skilled in the art upon reference to the description. It is therefore intended that the appended claims accomplish any such modifications or embodiments.

We claim:

1. A mobile training system, the system comprising:
at least one contact surface of the system;
a microprocessor that processes a count relating to the amount of times the at least one contact surface touches another surface outside of the mobile training system;
a storage that records the count; and
a communications module that transmits the count.
